(19) United States
(12) Patent Application Publication
(10) Pub. No.: US 2024/0285453 A1
(43) Pub. Date: Aug. 29, 2024

(54) WHEELCHAIR

(71) Applicant: myREability LLC, Canton, GA (US)

(72) Inventors: Grant Van Brewer, Canton, GA (US); Charles Schenck Wiley, Canton, GA (US)

(21) Appl. No.: 18/584,776

(22) Filed: Feb. 22, 2024

Related U.S. Application Data
(60) Provisional application No. 63/486,612, filed on Feb. 23, 2023.

(51) Int. Cl. A61G 5/10; A61G 5/12

(52) U.S. Cl. CPC A61G 5/10; A61G 5/1013; A61G 5/122; A61G 5/128; A61G 5/104

(57) ABSTRACT

A wheelchair includes a seat, a backrest configured to couple to the seat, a pair of axle supports configured to couple to the seat where the pair of axle supports is configured to support an axle and a pair of rear wheels, a central hub configured to couple to the seat, a pair of caster supports configured to couple to the central hub where the pair of caster supports is configured to support a pair of front caster wheels, and a footrest configured to couple to the pair of caster supports.

### CROSS-REFERENCE TO RELATED PATENT APPLICATION

This application claims the benefit of and priority to U.S. Provisional Patent Application No. 63/486,612, filed Feb. 23, 2023, which is incorporated herein by reference in its entirety.

### BACKGROUND

Wheelchairs may be used to help transport fatigued, injured, or disabled persons. However, typical wheelchairs are often heavy, cumbersome to stow or transport, and unergonomically designed.

### SUMMARY

One embodiment relates to a wheelchair. The wheelchair includes a seat, a backrest configured to couple to the seat, a pair of axle supports configured to couple to the seat where the pair of axle supports is configured to support an axle and a pair of rear wheels, a central hub configured to couple to the seat, a pair of caster supports configured to couple to the central hub where the pair of caster supports is configured to support a pair of front caster wheels, and a footrest configured to couple to the pair of caster supports

Another embodiment relates to a wheelchair. The wheelchair includes a seat assembly, a backrest configured to couple to the seat assembly, a pair of axle supports configured to couple to the seat assembly, a central hub configured to couple to the seat assembly, a pair of front wheel supports configured to couple to the central hub, and a footrest configured to couple to the pair of front wheel supports. The seat assembly includes a pair of rear seat supports, a pair of front seat supports, a rear seat hub, and a center seat hub.

Still another embodiment relates to a wheelchair. The wheelchair includes a seat assembly, a backrest, a backrest post, a pair of axle supports configured to couple to the seat assembly, a central hub, a pair of front wheel supports, a footrest, a first plurality of connectors, and a pair of magnetic braking assemblies. The first plurality of connectors are configured to extend between the seat assembly, the central hub, the pair of front wheel supports, and the footrest. The seat assembly includes a pair of rear seat supports, a pair of front seat supports, a rear seat hub, a center seat hub, and a second plurality of connectors configured to extend between the pair of rear seat supports, the pair of front seat supports, the rear seat hub, and the center seat hub. The backrest post is configured to extend between the rear seat hub and the backrest. At least one of (a) at least one of the first plurality of connectors has an adjustable length or (b) at least one of the second plurality of connectors has an adjustable length.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a wheelchair including a chassis, according to an exemplary embodiment.

FIG. 2 is a front view of the wheelchair of FIG. 1, according to an exemplary embodiment.

FIG. 3 is a perspective view of the chassis of FIG. 1, according to an exemplary embodiment.

FIG. 4 is a front view of the chassis of FIG. 3, according to an exemplary embodiment.

FIG. 5 is a rear view of the chassis of FIG. 3, according to an exemplary embodiment.

FIG. 6 is a side view of the chassis of FIG. 3, according to an exemplary embodiment.

FIG. 7 is a top view of the chassis of FIG. 3, according to an exemplary embodiment.

FIG. 8 is a bottom view of the chassis of FIG. 3, according to an exemplary embodiment.

FIG. 9 is a perspective view of an accessory usable with the chassis of FIG. 3, according to an exemplary embodiment.

FIG. 10 is a perspective view of a wheelchair including a chassis, according to another exemplary embodiment.

FIGS. 11 and 12 are various views of the chassis of FIG. 9, according to an exemplary embodiment.

FIGS. 13-15 are various views of the chassis of FIG. 9, according to another exemplary embodiment.

FIG. 16 is a cross-sectional view of the chassis of FIGS. 13-15 having a first internal structure, according to an exemplary embodiment.

FIG. 17 is a cross-sectional view of the chassis of FIGS. 13-15 having a second internal structure, according to an exemplary embodiment.

FIGS. 18-23 are various views of the wheelchair of FIG. 1 with a multicomponent seat assembly, according to an exemplary embodiment.

FIGS. 24-32 are various views of the wheelchair of FIGS. 18-23 with size adjustability, according to an exemplary embodiment.

FIGS. 33-38 are various views of the a wheel hub assembly of the wheelchair of FIGS. 24-32 with size adjustability functionality, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a wheelchair includes a chassis, rear wheels, and front wheels. The chassis includes a seat, a backrest coupled to the seat, axle support brackets coupled to the seat, a wheel axle coupled to the axle support brackets, a central hub coupled to the seat, caster supports coupled to the central hub, and a footrest coupled to the caster supports. The rear wheels are coupled to the wheel axle. The front wheels are coupled to the caster supports. In some embodiments, various components of the wheelchair and/or the chassis can be manufactured using additive manufacturing processes. In some embodiments, the seat, the central hub, the caster supports, and the footrest are coupled together with a plurality of tubular members or rods (e.g., pultruded carbon fiber tubes or rods, polymer tubes or rods, etc.) to form a three-dimensional truss frame. In some embodiments, two or more of the seat, the central hub, the caster supports, and the footrest are integrally formed (e.g., via an additive manufacturing process, via a mold manufacturing process, etc.). In some embodiments, the seat and the backrest are coupled together with an angle-adjustable and/or a height-adjustable connector.

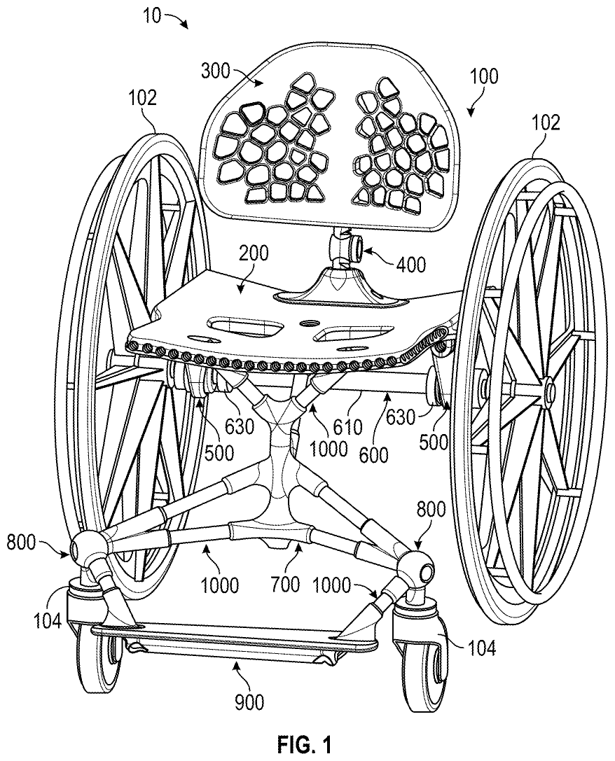

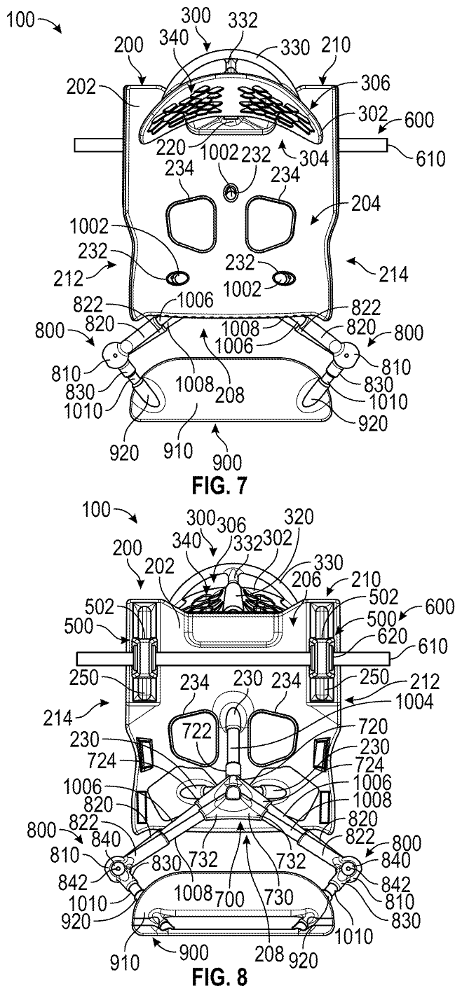

According to the exemplary embodiment shown in FIGS. 1-8, a wheelchair assembly, shown as wheelchair 10, includes various components that can be manufactured via an additive manufacturing process, providing various advantages over traditional wheelchair designs. First, additive manufacturing facilitates designing various components of the wheelchair 10 to be both strength and weight optimized (e.g., various apertures, holes, slots, recesses, etc. can be formed within the components to eliminate unnecessary weight while maintaining sufficient strength in certain areas). Second, additive manufacturing facilitates distributing the wheelchair 10 as a kit. In one embodiment, the kit includes additive manufactured or “printed” components and non-additive manufactured or “non-printed” components that can be shipped and assembled by the end user/seller. In another embodiment, (a) the additive manufactured components can be sent to the end user/seller as a data file and (b) the non-additive manufactured components can be shipped to or locally sourced by the end user/seller. The components in the data file can then be printed at the end user/seller's location and assembled with the non-additive manufactured components (e.g., reducing shipping costs, reducing product package sizes, reducing transportation emissions, etc.).

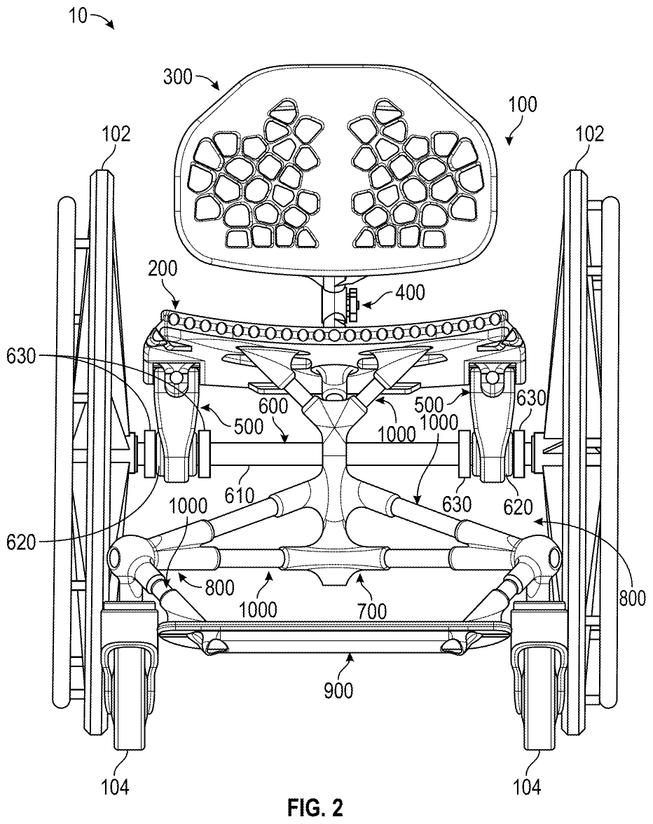

As shown in FIGS. 1 and 2, the wheelchair 10 includes a chassis or chassis assembly, shown as user support assembly 100, a first pair of rear wheels, shown as rear wheels 102, and a pair of front wheels, shown as front caster wheels 104. As shown in FIGS. 1-8, the user support assembly 100 includes (a) a seat bottom, shown as seat 200, (b) a seat back, shown as backrest 300, (c) a connector or coupler, shown as backrest post 400, coupling the backrest 300 to the seat 200, (d) axle supports, shown as axle brackets 500, coupled to the seat 200, (e) an axle assembly, shown as rear axle assembly 600, coupled to and supported by the axle brackets 500, (f) a central support, shown as central hub 700, coupled to the seat 200, (g) a pair of front wheel supports, shown as front caster supports 800, coupled to the central hub 700, and (h) a foot support, shown as footrest 900, coupled to the front caster supports 800. As shown in FIGS. 1 and 2, the rear wheels 102 are coupled to and supported by opposing ends of the rear axle assembly 600, and the front caster wheels 104 are coupled to the front caster supports 800. As shown in FIGS. 1-8, the seat 200, the central hub 700, the front caster supports 800, and the footrest 900 are coupled together with a plurality of frame members (e.g., tubes, rods, pultruded carbon fiber tubes or rods, polymer tubes or rods, etc.), shown as connectors 1000, such that the seat 200, the central hub 700, the front caster supports 800, the footrest 900, and the connectors 1000 form a three-dimensional (“3D”) truss frame.

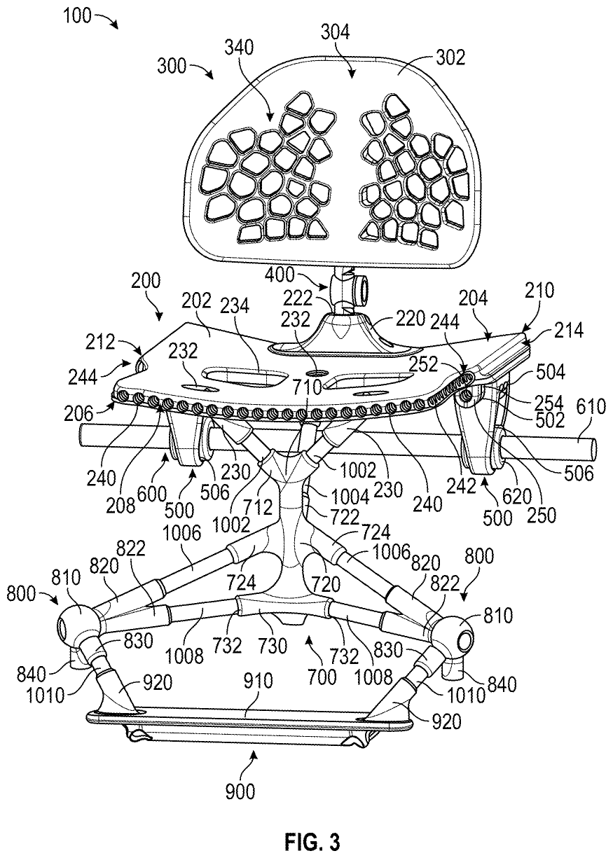

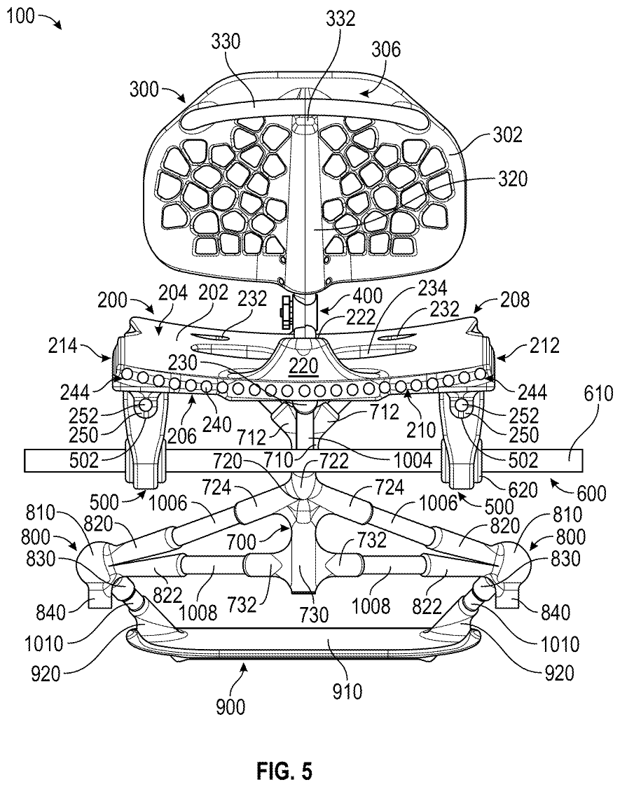

As shown in FIGS. 3-8, the seat 200 includes a main body, shown as seat plate 202. The seat plate 202 has a first surface, shown as upper surface 204, an opposing second surface, shown as lower surface 206, a first end, shown as front end 208, an opposing second end, shown as rear end 210, a first side, shown as right side 212, and an opposing second side, shown as left side 214. In some embodiments, the seat 200 includes a cushion or pad that is supported by the upper surface 204 of the seat plate 202. As shown in FIGS. 3 and 5-7, the seat 200 includes a support or interface, shown as lower backrest post support 220, integrally formed with the seat plate 202 and extending upward from the upper surface 204 of the seat plate 202 at a position proximate the rear end 210 of the seat plate 202. As shown in FIGS. 3 and 5, the lower backrest post support 220 defines an aperture, shown as post aperture 222, that receives a lower end of the backrest post 400.

As shown in FIGS. 3-6 and 8, the seat 200 includes a plurality of central hub interfaces, shown as seat protrusions 230, integrally formed with the seat plate 202 and extending downward from the lower surface 206 of the seat plate 202 at positions spaced about a central portion of the seat plate 202. According to an exemplary embodiment, the seat 200 includes three seat protrusions 230 arranged in a triangular shape or orientation. In other embodiments, the seat 200 includes more than three seat protrusions 230 (e.g., four, five, etc.). As shown in FIGS. 3, 5, and 7, the seat plate 202 and the seat protrusions 230 cooperatively define a plurality of passages, shown as connector slots 232. According to the exemplary embodiment shown in FIGS. 3, 5, and 7, the connector slots 232 extend through the upper surface 204 of the seat plate 202. In other embodiments, the connector slots 232 do not extend completely though the seat plate 202 (i.e., the seat plate 202 does not define holes in the upper surface 204 that align with the connector slots 232). As shown in FIGS. 3-8, the seat plate 202 defines a pair of large apertures, shown as cutouts 234. According to an exemplary embodiment, the cutouts 234 reduce the overall weight of the seat plate 202 and are positioned to correspond with the bones of the pelvis of a person sitting on the seat 200 to provide a more comfortable sitting experience.

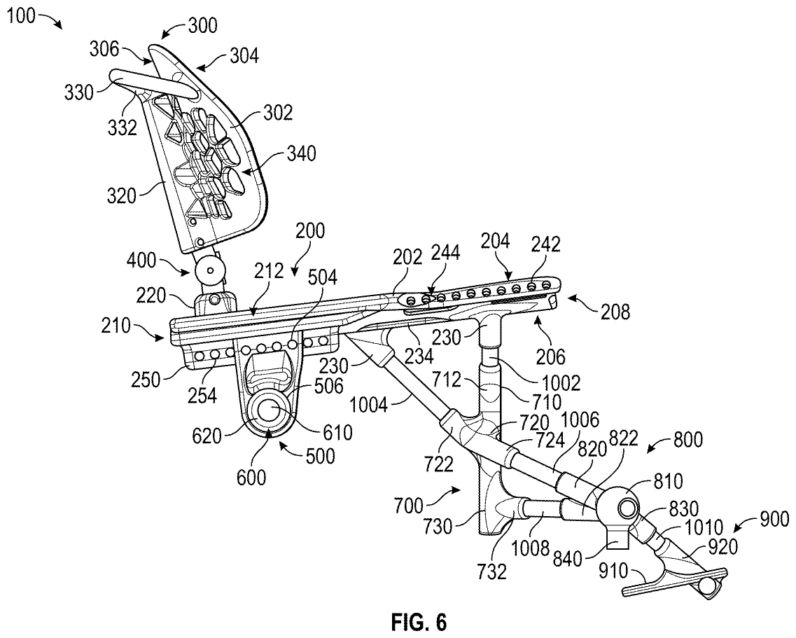

As shown in FIGS. 3-5, the seat plate 202 defines a first plurality of through-holes, shown as fore-and-aft through-holes 240, spaced along at least a portion of the lateral width of the seat plate 202 and that extend at least partially (e.g., entirely, only partially, etc.) through the longitudinal length of the seat plate 202 between the front end 208 and the rear end 210 of the seat plate 202. As shown in FIGS. 3 and 6, the seat plate 202 defines a second plurality of through-holes, shown as lateral through-holes 242, spaced along at least a portion of the longitudinal length of the seat plate 202 and that extend at least partially (e.g., entirely, only partially, etc.) through the lateral width of the seat plate 202 between the right side 212 and the left side 214 of the seat plate 202. According to an exemplary embodiment, the seat plate 202 has a contoured shape (e.g., laterally arching, longitudinally arching, etc.) and the fore-and-aft through-holes 240 and/or the lateral through-holes 242 follow the contoured shape. In some embodiments, the seat plate 202 does not define the fore-and-aft through-holes 240 and/or the lateral through-holes 242 (e.g., the seat plate 202 is solid). According to an exemplary embodiment, the fore-and-aft through-holes 240 and the lateral through-holes 242 are configured to reduce the overall weight of the seat plate 202. In some embodiments, strengthening members (e.g., pultruded carbon fiber tubes) are inserted into and through the fore-and-aft through-holes 240 or lateral through-holes 242 to increase the rigidity of the seat plate 202 and/or to accommodate a larger or heavier user of the wheelchair 10.

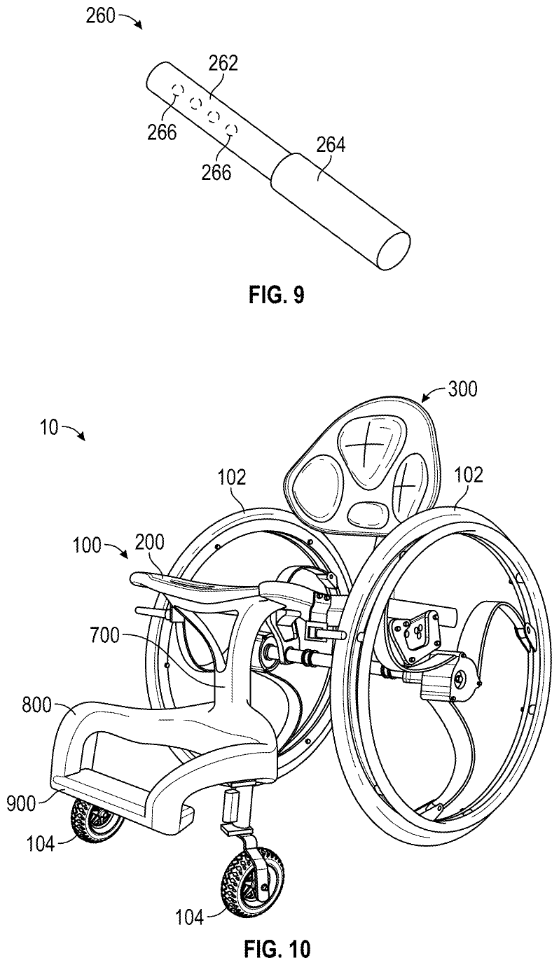

As shown in FIGS. 3-6, the seat plate 202 defines a pair of interfaces (e.g., grooves, recesses, through-holes, etc.), shown as accessory slots 244, positioned proximate the right side 212 and the left side 214 of the seat plate 202. According to an exemplary embodiment, various accessories can be coupled to the seat 200 via the accessory slots 244. As shown in FIG. 9, one such accessory, shown as accessory 260, includes a first portion, shown as coupling portion 262, and a second portion, shown as accessory portion 264. The coupling portion 262 is configured as an elongated tube, rod, or poll-shaped element that can be inserted into the accessory slots 244 (from the front end 208 or the rear end 210 of the seat plate 202) to couple the accessory 260 to the seat 200. The coupling portion 262 may be secured within a respective accessory slot 244 via an interference fit, using adhesive, epoxy, or glue, using a fastener (e.g., through the side of the accessory slot 244, positioned to receive a free end of the coupling portion 262 that extends from the accessory slot 244 opposite the accessory portion 264, etc.), and/or a retractable detent along the coupling portion 262 that is spring loaded and extends through a hole in the sidewall of the accessory slot 244. According to the exemplary embodiment shown in FIG. 9, the accessory portion 264 is configured as a handle (e.g., a padded handle). In other embodiments, the accessory portion 264 provides another type of accessory such as an arm rest, a cup holder, a fixed tray, a pivoting or folding tray, an electronic device (e.g., a smartphone, a cell phone, a tablet, a laptop, etc.) holder, and/or still another suitable type of accessory.

As shown in FIGS. 3-6 and 8, the seat 200 includes a pair of axle support bracket interfaces, shown as axle bracket support rails 250, integrally formed with the seat plate 202, extending downward from the lower surface 206 of the seat plate 202, positioned proximate the right side 212 and the left side 214 of the seat plate 202, and extending at least partially from the rear end 210 toward the front end 208 of the seat plate 202. As shown in FIGS. 3-6, each of the axle bracket support rails 250 defines (a) a first, elongated aperture, shown as rail slot 252, that extends through the longitudinal length of the axle bracket support rails 250 and (b) a plurality of second apertures, shown as side apertures 254, that extend laterally through the axle bracket support rails 250 and are spaced along the longitudinal length thereof. In some embodiments, the rail slots 252 are configured to receive the coupling portions 262 of the accessories 260 to facilitate coupling respective accessories 260 to the axle bracket support rails 250 of the seat 200 (in addition to or in place of the accessory slots 244). In some embodiments, as shown in FIG. 9, the coupling portion 262 of the accessory 260 includes a plurality of apertures, shown as apertures 266, spaced along the longitudinal length thereof. According to an exemplary embodiment, the apertures 266 are configured to align with the side apertures 254 of the axle bracket support rails 250. When aligned, one or more fasteners (e.g., a bolt, a rod, etc.) can be inserted through one or more of the apertures 266 of the accessory 260 and one or more side apertures 254 of the axle bracket support rail 250 to secure the coupling portion 262 of the accessory 260 within the respective rail slot 252.

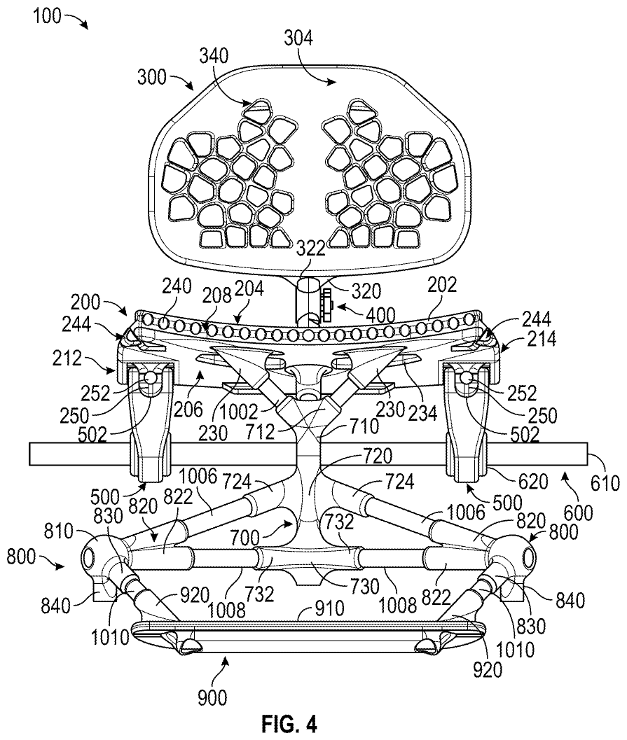

As shown in FIGS. 3-8, the backrest 300 includes a main body, shown as contoured back plate 302. The contoured back plate 302 has a first side, shown as front side 304, and an opposing second side, shown as rear side 306. As shown in FIGS. 4-6 and 8, the backrest 300 includes a support or interface, shown as upper backrest post support 320, integrally formed with and extending along the rear side 306 of the contoured back plate 302. As shown in FIG. 4, the upper backrest post support 320 defines an aperture, shown as post aperture 322, that receives an upper end of the backrest post 400, thereby coupling the backrest 300 to the seat 200. In some embodiments, the backrest post 400 is angle-adjustable and, thereby, facilitates user adjustment of an angle of the backrest 300 relative to the seat 200 (e.g., an incremental hinge with a push button to adjust the angle and fold the backrest 300 flat, for user comfort, to fold the backrest 300 for improved stowability and transportability, etc.). In some embodiments, the backrest post 400 is additionally or alternatively height-adjustable and, thereby, facilitates user adjustment of a height of the backrest 300 relative to the seat 200.

As shown in FIGS. 5-8, the backrest 300 includes a hand support, shown as handle 330, integrally formed with and extending from opposing lateral sides of the rear side 306 of the contoured back plate 302. In other embodiments, the handle 330 is detachably coupled to the contoured back plate 302 (e.g., using fasteners). As shown in FIGS. 5-8, the handle 330 includes a support member, shown as central support 332, extending from a central portion of the handle 330 to an upper portion of the backrest post support 320. As shown in FIGS. 3-8, the contoured back plate 302 defines a plurality of apertures, shown as back apertures 340. According to an exemplary embodiment, the back apertures 340 reduce the overall weight of the contoured back plate 302. In some embodiments, the backrest 300 includes a cushion or pad that is supported by the front side 304 of the contoured back plate 302.

As shown in FIGS. 3-5 and 8, an upper portion of each of the axle brackets 500 defines a cutout or notch, shown as rail recess 502, that extends along a longitudinal length thereof and that slidably engages with and receives a respective one of the axle bracket support rails 250 of the seat plate 202. As shown in FIGS. 3 and 6, the upper portion of each of the axle brackets 500 defines a plurality of apertures, shown as side apertures 504, that (a) are spaced along the longitudinal length thereof, (b) extend laterally across the axle brackets 500 through the rail recesses 502, and (c) slidably align with a subset of the side apertures 254 of a respective one of the axle bracket support rails 250 received within the rail recess 502. According to an exemplary embodiment, the axle brackets 500 are configured to selectively translate along the axle bracket support rails 250 (e.g., to facilitate adjusting a forward-backward or fore-aft position of the rear axle assembly 600). When a desired position for the axle brackets 500 is selected, one or more fasteners (e.g., bolts, pins, clips, etc.) can be inserted through one or more of the side apertures 504 of the axle brackets 500 and one or more apertures of the side apertures 254 of the axle bracket support rails 250 to secure the axle brackets 500 in position along the axle bracket support rails 250. As shown in FIGS. 3 and 6, a lower portion of each of the axle brackets 500 defines an axle aperture or interface, shown as axle bore 506, configured to receive and support a portion of the rear axle assembly 600, as described in more detail herein. According to an exemplary embodiment, the axle brackets 500 have an “I-beam” design or structure.

As shown in FIGS. 1-8, the rear axle assembly 600 includes an elongated shaft, shown as axle shaft 610, a pair of bearings (e.g., dry run bearings), shown as axle bearings 620, and a plurality of stops, shown as stop collars 630. As shown in FIGS. 1 and 2, the rear wheels 102 are coupled to opposing ends of the axle shaft 610. As shown in FIGS. 1-6 and 8, the axle bearings 620 are disposed along the axle shaft 610, and received by and supported within the axle bores 506 of the axle brackets 500. Accordingly, the axle brackets 500 are configured to couple the rear axle assembly 600 and the rear wheels 102 to the seat 200. As shown in FIGS. 1 and 2, the stop collars 630 are positioned along the axle shaft 610 on each side of the axle brackets 500 and the axle bearings 620. According to an exemplary embodiment, the stop collars 630 are configured to prevent lateral shifting of the rear axle assembly 600 through the axle brackets 500 and relative to the seat 200.

As shown in FIGS. 3-6 and 8, the central hub 700 has a first or upper support portion, shown as upper support 710, a second or middle support portion, shown as center support 720, and a third or lower support portion, shown as lower support 730. The upper support 710 includes a pair of upper interfaces, shown as upper protrusions 712, that extend upward from the upper support 710 at an outward angle in a “Y-shape.” The center support 720 includes (a) a first center interface, shown as center tail protrusion 722, extending upward from a rear side of the center support 720 at an outward angle and (b) a pair of second center interfaces, shown as front, center protrusions 724, that extend outward from opposing sides of the center support 720 at a downward and forward angle. The lower support 730 includes a pair of lower interfaces, shown as lower protrusions 732, that extend outward from opposing sides of the lower support 730 at a forward angle. In some embodiments, the upper support 710 is a separate component from the remainder of the central hub 700 (e.g., the upper support 710 is coupled to the center support 720 via a respective one of the connectors 1000). In some embodiments, the upper support 710, the center support 720, and the lower support 730 are integrally formed (e.g., 3D printed, cast, molded, etc.) as a unitary structure.

As shown in FIGS. 3, 4, and 6, the connectors 1000 include first connectors, shown as front seat connectors 1002, that extend between and are received by two of the seat protrusions 230 positioned closer to the front end 208 of the seat plate 202 and the upper protrusions 712 of the upper support 710 of the central hub 700. As shown in FIGS. 3, 5, 6, and 8, the connectors 1000 include a second connector, shown as rear seat connector 1004, that extends between and is received by a respective one of the seat protrusions 230 positioned closer to the rear end 210 of the seat plate 202 and the center tail protrusion 722 of the center support 720 of the central hub 700. Accordingly, the front seat connectors 1002 and the rear seat connector 1004 couple the seat 200 and the central hub 700 together.

As shown in FIGS. 3-8, the front caster supports 800 include a main body, shown as caster support hub 810, having (a) a first interface, shown as central hub protrusion 820, that extends inward from the caster support hub 810 at an upward and rearward angle, (b) a second interface, shown as lower central hub protrusion 822, positioned beneath the central hub protrusion 820 and that extends inward from the caster support hub 810 at a rearward angle, (c) a third interface, shown as footrest protrusion 830, that extends inward from the caster support hub 810 at an downward and forward angle, and (d) a fourth interface, shown as caster mount 840, that extends downward from the caster support hub 810. As shown in FIG. 8, each of the caster mounts 840 defines an aperture, shown as treaded aperture 842. According to an exemplary embodiment, the threaded apertures 842 of the caster mounts 840 are configured to treadably receive a threaded post of the front caster wheels 104 to detachably couple the front caster wheels 104 to the front caster supports 800 (like shown in FIGS. 1 and 2).

As shown in FIGS. 3-8, the connectors 1000 include (a) third connectors, shown as upper caster support connectors 1006, that extend between and are received by the front, center protrusions 724 of the center support 720 of the central hub 700 and the central hub protrusions 820 of the front caster supports 800 and (b) fourth connectors, shown as lower caster support connectors 1008, that extend between and are received by the lower protrusions 732 of the lower support 730 of the central hub 700 and the lower central hub protrusions 822 of the front caster supports 800. Accordingly, the upper caster support connectors 1006 and the lower caster support connectors 1008 couple the central hub 700 and the front caster supports 800 together.

As shown in FIGS. 3-8, the footrest 900 includes a main body, shown as foot platform 910, having a pair of interfaces, shown as caster protrusions 920, that extend outward from opposing lateral ends of the foot platform 910 at an upward and rearward angle. The connectors 1000 include fifth connectors, shown as footrest connectors 1010, that extend between and are received by the footrest protrusions 830 of the front caster supports 800 and the caster protrusions 920 of the footrest 900. Accordingly, the footrest connectors 1010 couple the front caster supports 800 and the footrest 900 together. According to an exemplary embodiment, (a) the inward angled arrangement of the footrest 900 and the front caster supports 800 and (b) the lack of any structure being present vertically above the front caster supports 800 facilitates positioning the wheelchair 10 closer to vehicles and, thereby, makes ingress into and egress from the vehicle substantially easier for a user of the wheelchair 10.

According to an exemplary embodiment, the seat 200, the backrest 300, the axle brackets 500, the central hub 700, the front caster supports 800, and the footrest 900 are configured (e.g., designed, structured, etc.) to facilitate the manufacture thereof using an additive manufacturing process (e.g., 3D printed from resin, stereolithography (“SLA”) printing, masked-SLA (“MSLA”), 3D printed from metal, etc.). The seat 200, the backrest 300, the axle brackets 500, the central hub 700, the front caster supports 800, and the footrest 900 can, therefore, be produced (e.g., printed) by a manufacturer of the wheelchair 10, the seller of the wheelchair 10, and/or the end user of the wheelchair 10. Once printed, the wheelchair 10 can be assembled with the non-additive manufactured components (e.g., the rear wheels 102, the front caster wheels 104, the backrest post 400, the rear axle assembly 600, the connectors 1000, etc.). For example, the wheelchair 10 may be assembled by (a) coupling the backrest 300 to the seat 200 with the backrest post 400, (b) coupling the axle brackets 500 to the seat 200 using fasteners (e.g., bolts, pins, etc.), (c) coupling the seat 200, the central hub 700, the front caster supports 800, and the footrest 900 together using the connectors 1000 (which may be epoxied within the various protrusions or interfaces of the seat 200, the central hub 700, the front caster supports 800, and the footrest 900), (d) coupling the rear axle assembly 600 to the axle brackets 500, (c) coupling the rear wheels 102 to the rear axle assembly 600, and (f) coupling the front caster wheels 104 to the front caster supports 800. Such an assembly process facilitates manufacture and assembly of the wheelchair 10 by one party or multiple parties. An example of the user support assembly 100 of the wheelchair 10 produced using additive manufacturing techniques is show in the pictures included in the Appendix submitted herewith, which is incorporated herein by reference in its entirety. According to an exemplary embodiment, the user support assembly 100 of the wheelchair 10 (or the whole wheelchair 10) has a total weight of less than twenty pounds when fully assembled (including padding or cushions for the seat 200 and the backrest 300).

In some embodiments, the wheelchair 10 is provided as a kit. In one embodiment, the kit includes additive manufactured or “printed” components (e.g., the seat 200, the backrest 300, the axle brackets 500, the central hub 700, the front caster supports 800, and the footrest 900) and non-additive manufactured or “non-printed” components (e.g., the rear wheels 102, the front caster wheels 104, the backrest post 400, the rear axle assembly 600, and the connectors 1000) that can be shipped and assembled by the end user/seller. In another embodiment, (a) the additive manufactured components can be sent to the end user/seller as a data file and (b) the non-additive manufactured components can be shipped to or locally sourced by the end user/seller. The components in the data file can then be printed by the end user/seller and assembled with the non-additive manufactured components (e.g., reducing shipping costs, reducing product package sizes, reducing transportation emissions, etc.).

According to the exemplary embodiment shown in FIGS. 10-17, the seat 200, the central hub 700, the front caster supports 800, and the footrest 900 of the user support assembly 100 are integrally formed (e.g., via an additive manufacturing process, via a mold manufacturing process, without using the connectors 1000, etc.). By way of example, the seat 200, the central hub 700, the front caster supports 800, and the footrest 900 may be produced as a unitary structure using carbon fiber-reinforced plastic (“CFRP”). By way of another example, the seat 200, the central hub 700, the front caster supports 800, and the footrest 900 may be produced as a unitary structure using 3D printed resin.

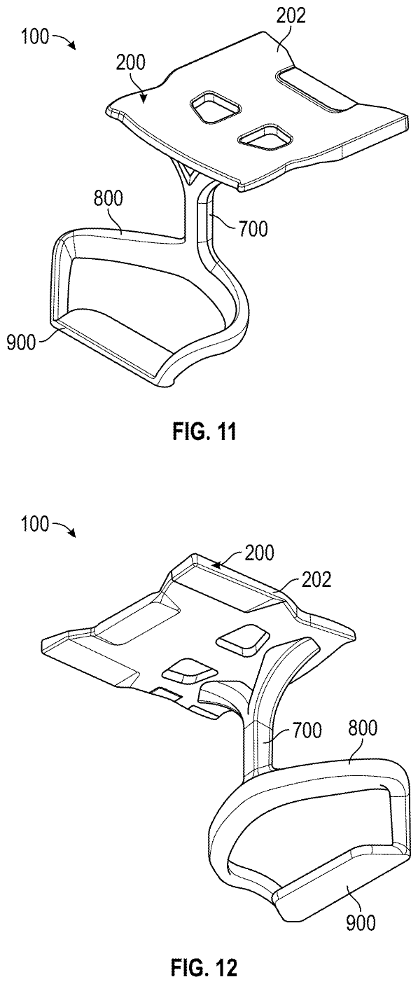

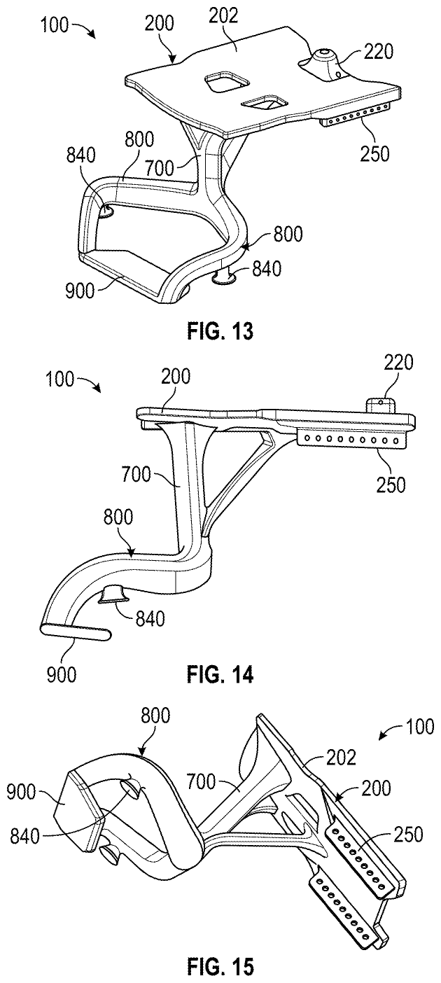

As shown in FIGS. 11 and 12, the upper portion of the central hub 700 has two arms arranged in a Y-shaped support structure coupled to the lower surface 206 of the seat plate 202 of the seat 200. As shown in FIGS. 13-15, the upper portion of the central hub 700 has three arms arranged in a tripod-shaped support structure coupled to the lower surface 206 of the seat plate 202 of the seat 200 (e.g., to reinforce the connection between the central hub 700 and the seat 200 and, thereby, reduce the bending moment that the design with the Y-shaped support may experience). As shown in FIGS. 13 and 14, the lower backrest post support 220 is integrally formed with the seat plate 202. As shown in FIGS. 13-15, the axle bracket support rails 250 are integrally formed with the seat plate 202. As shown in FIGS. 13-15, the caster mounts 840 are integrally formed with the front caster supports 800.

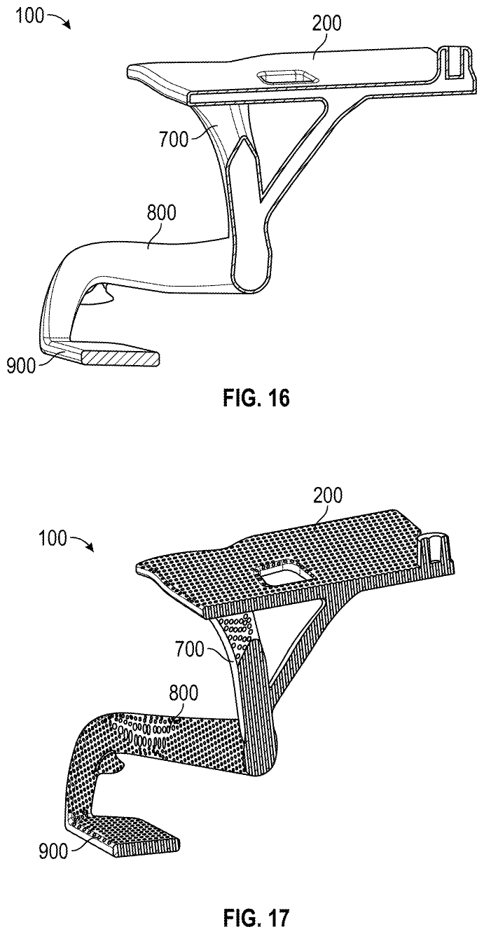

As shown in FIG. 16, the seat 200, the central hub 700, the front caster supports 800, and the footrest 900 of the user support assembly 100 are manufactured with a hollow or open-shell structure to reduce the overall weight thereof. As shown in FIG. 17, the seat 200, the central hub 700, the front caster supports 800, and the footrest 900 of the user support assembly 100 are manufactured with an internal lattice structure with material removed or not present in certain areas to reduce the overall weight thereof. In some embodiments, the seat 200, the central hub 700, the front caster supports 800, and the footrest 900 of the user support assembly 100 are manufactured with a solid or closed-shell structure.

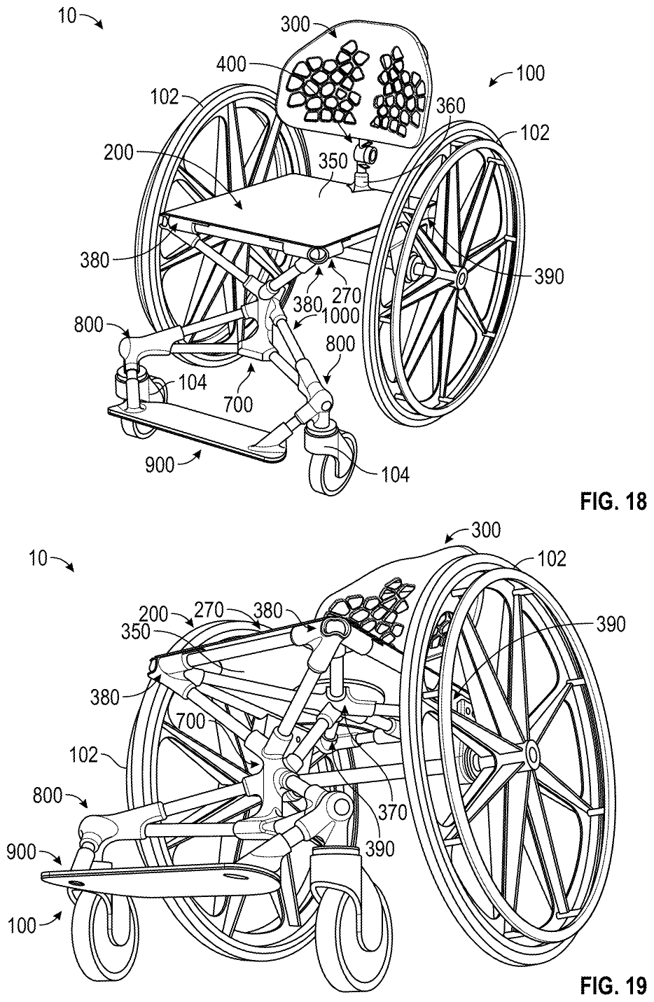

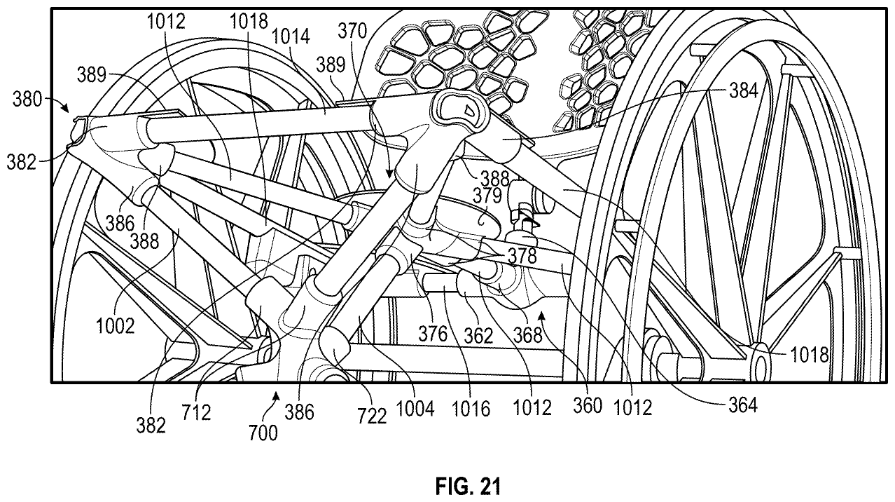

According to the exemplary embodiment shown in FIGS. 18-23, the seat 200 of the user support assembly 100 is configured as an assembly, shown as seat assembly 270, including plurality of smaller, segmented components that are assembled, rather than having a monolithic or unitary seat pan structure (e.g., like in FIGS. 1-9). Such a segmented or assembled seat pan design may provide enhanced strength and rigidity, while further reducing the overall weight of the user support assembly 100.

As shown in FIGS. 18-23, the seat assembly 270 includes user support plate, shown as seat plate 350, a first support, shown as rear hub 360, a second support, shown as center seat support 370, a pair of third supports, shown as front seat supports 380, and a pair of fourth seat supports, shown as rear seat supports 390, and a plurality of the connectors 1000. According to an exemplary embodiment, the rear hub 360, the center seat support 370, the front seat supports 380, the rear seat supports 390, and the connectors 1000 form a truss or space frame that supports the seat plate 350. In some embodiments, the seat plate 350 is manufactured from or includes carbon fiber (e.g., CFRP). In some embodiments, the seat plate 350 is manufactured from or includes another material (e.g., plastic, metal, etc.). In some embodiments, the seat assembly 270 includes a cushion or pad that is supported by the seat plate 350.

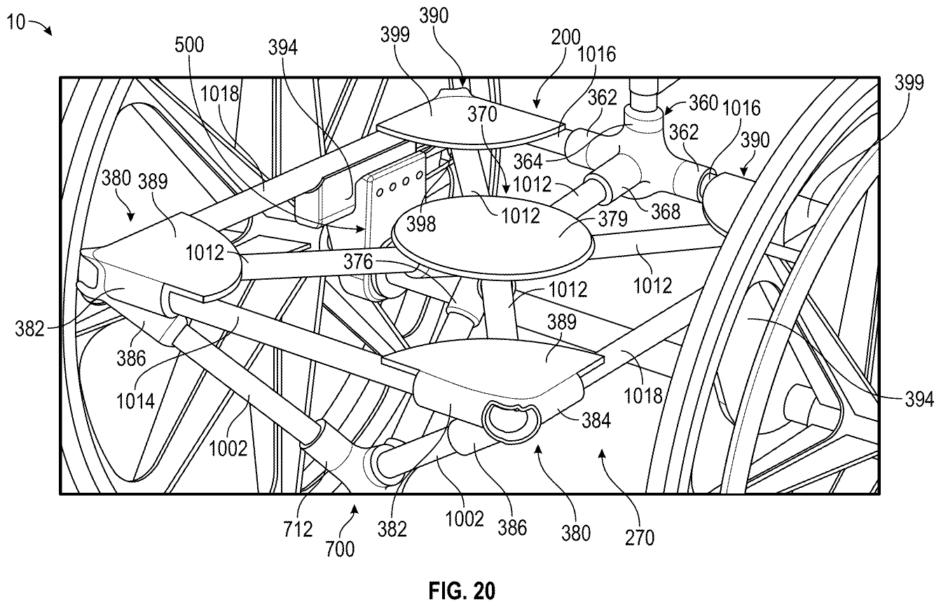

As shown in FIGS. 20-22, the rear hub 360 includes a pair of first interfaces, shown as rear seat support protrusions 362, extending laterally outward (e.g., left and right) towards the rear seat supports 390; a second interface, shown as lower backrest post protrusion 364, extending vertically upward; and a third interface, shown as center seat support protrusion 368, extending longitudinally forward towards the center seat support 370. As shown in FIGS. 20-23, the center seat support 370 includes a first interface, shown as central hub protrusion 376, extending downward at a forward angle towards the central hub 700; a second plurality of interfaces, shown as support protrusions 378, extending horizontally outward towards the rear hub 360, the front seat supports 380, and the rear seat supports 390; and a third interface, shown as center seat plate pad 379, extending along an upper portion thereof. As shown in FIGS. 20-23, the front seat supports 380 include first interfaces, shown as front seat support protrusions 382, extending laterally inward towards each other; second interfaces, shown as rear seat support protrusions 384, extending longitudinally rearward towards the rear seat supports 390; third interfaces, shown as central hub protrusions 386, extending downward at an inward and rearward angle towards the central hub 700; fourth interfaces, shown as center seat support protrusions 388, extending horizontally/radially inward towards the center seat support 370; and fifth interfaces, shown as front seat plate pads 389, extending along an upper portions thereof. As shown in FIGS. 20, 22, and 23, the rear seat supports 390 include first interfaces, shown as rear hub protrusions 392, extending laterally inward towards the rear hub 360; second interfaces, shown as front seat support protrusions 394, extending longitudinally forward towards the front seat supports 380; third interfaces, shown as center seat support protrusions 398, extending horizontally/radially inward towards the center seat support 370; and fourth interfaces, shown as rear seat plate pads 399, extending along an upper portions thereof.

As shown in FIGS. 20-23, the connectors 1000 include sixth connectors, shown as center seat support connectors 1012, that extend between and are received by (a) the support protrusions 378 of the center seat support 370 and (b) the center seat support protrusion 368 of the rear hub 360, the center seat support protrusions 388 of the front seat supports 380, and the center seat support protrusions 398 of the rear seat supports 390. Accordingly, the center seat support connectors 1012 couple (a) the center seat support 370 with (b) the rear hub 360, the front seat supports 380, and the rear seat supports 390.

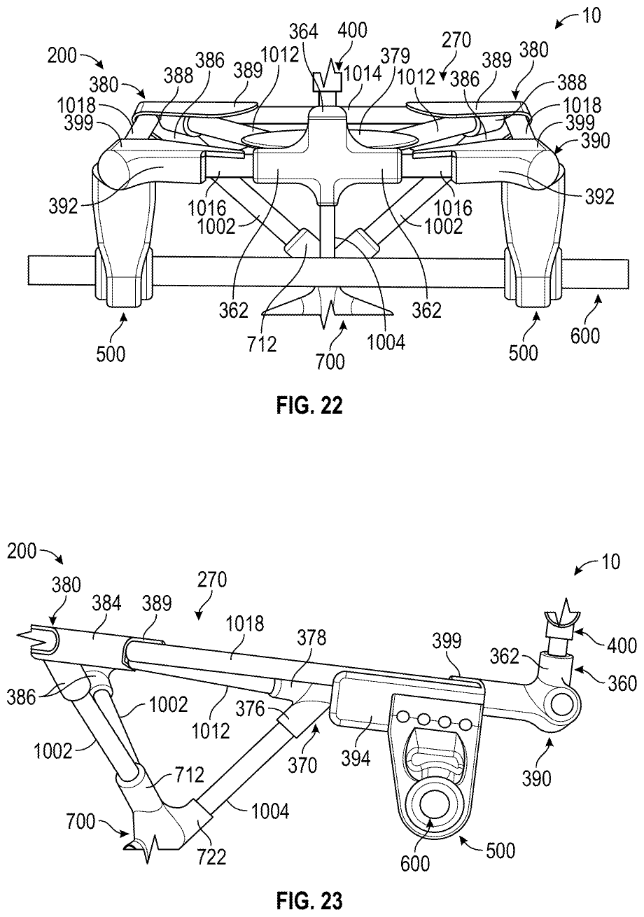

As shown in FIGS. 20-22, the connectors 1000 include a seventh connector, shown as front seat support connector 1014, that extends between and are received by the front seat support protrusions 382 of the front seat supports 380. Accordingly, the front seat support connector 1014 couples the front seat supports 380 together. As shown in FIGS. 20 and 22, the connectors 1000 include eighth connectors, shown as rear seat support connectors 1016, that extend between and are received by the rear seat support protrusions 362 of the rear hub 360 and the rear hub protrusions 392 of the rear seat supports 390. Accordingly, the rear seat support connectors 1016 couple the rear seat supports 390 with the rear hub 360. As shown in FIGS. 20-23, the connectors 1000 include ninth connectors, shown as side seat support connectors 1018, that extends between and are received by the rear seat support protrusions 384 of the front seat supports 380 and the front seat support protrusions 394 of the rear seat supports 390. Accordingly, the side seat support connectors 1018 couple the front seat supports 380 and the rear seat supports 390 together.

As shown in FIGS. 20 and 23, the front seat support protrusions 394 of the rear seat supports 390 extend longitudinally forward and define grooves along a longitudinal length thereof within which a portion of the side seat support connectors 1018 is recessed into. The front seat support protrusions 394 of the rear seat supports 390 have a shape similar to axle bracket support rails 250 and function similar thereto (e.g., the rail recess 502 of the axle brackets 500 slidably engages with and receives a respective one of the front seat support protrusions 394, the side apertures 504 of the axle brackets 500 slidably align with a subset of apertures like the side apertures 254 of a respective one of the front seat support protrusions 394.

As shown in FIGS. 20-23, the seat assembly 270 (e.g., the rear hub 360, the center seat support 370, the front seat supports 380, the rear seat supports 390, the center seat support connectors 1012, the front seat support connector 1014, the rear seat support connectors 1016, and the side seat support connectors 1018) is coupled to the central hub 700 using a subset of the connectors 1000. More specifically, (a) the front seat connectors 1002 extend between and are received by the central hub protrusions 386 of the front seat supports 380 and the upper protrusions 712 of the upper support 710 of the central hub 700 and (b) the rear seat connector 1004 extends between and is received by the central hub protrusion 376 of the center seat support 370 and the center tail protrusion 722 of the center support 720 of the central hub 700.

According to an exemplary embodiment, the center seat plate pad 379, the front seat plate pads 389, and the rear seat plate pads 399 interface with and engage the seat plate 350 such that the seat plate 350 is supported by the remainder of the seat assembly 270 and the user support assembly 100. In some embodiments, the seat plate 350 is detachably coupled to the center seat plate pad 379, the front seat plate pads 389, and the rear seat plate pads 399 (e.g., using fasteners, clamps, hook and loop fasteners, etc.). In some embodiments, the seat plate is fixedly coupled to the center seat plate pad 379, the front seat plate pads 389, and the rear seat plate pads 399 (e.g., with adhesive).

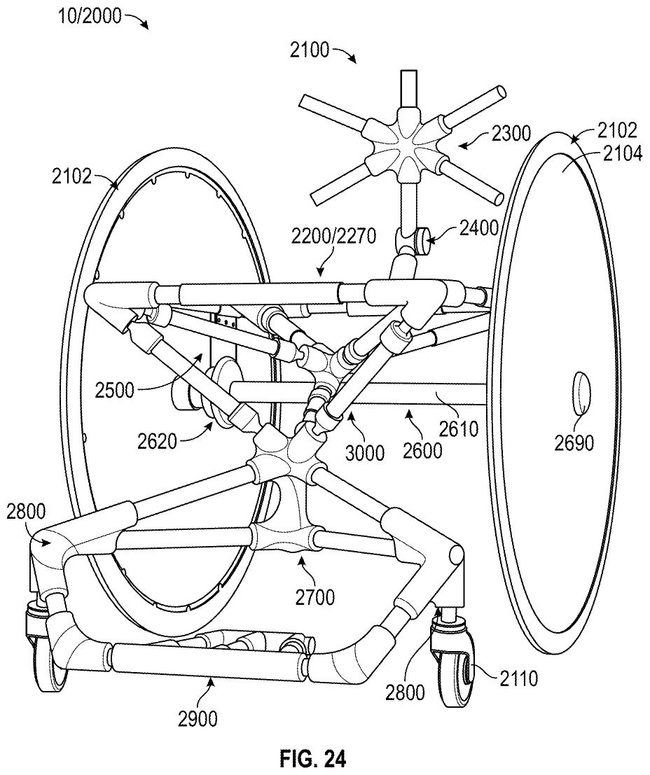

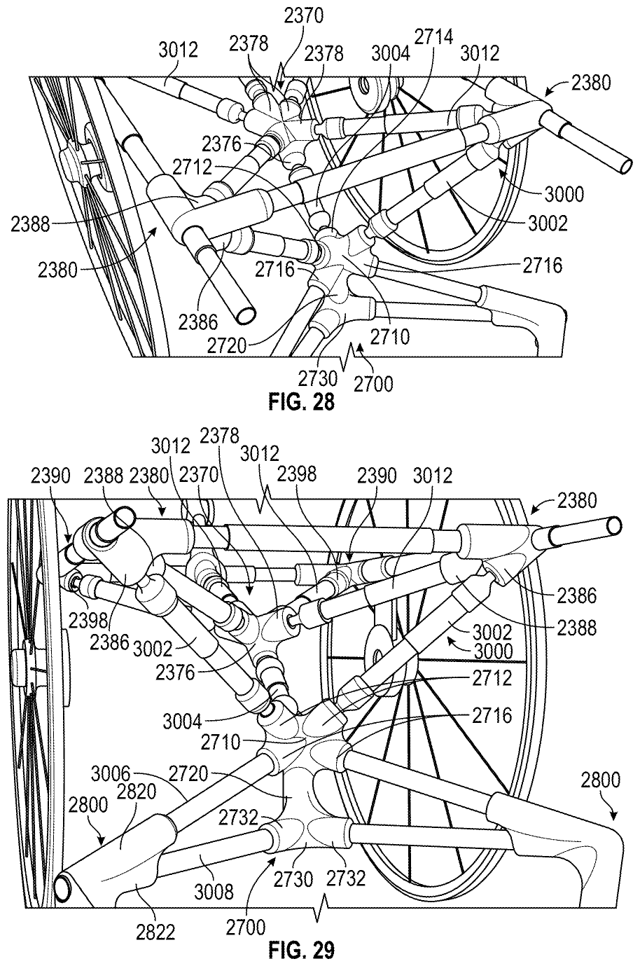

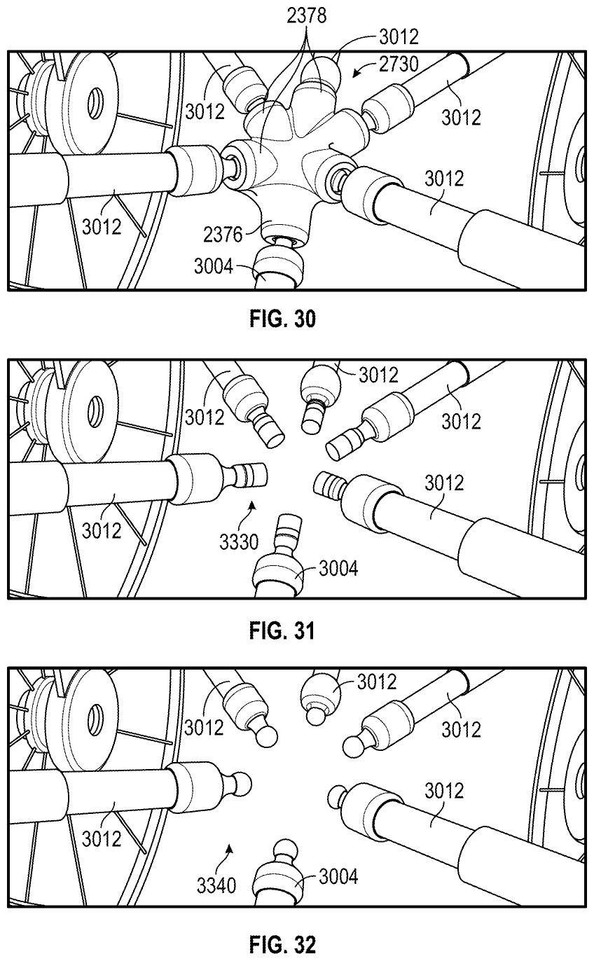

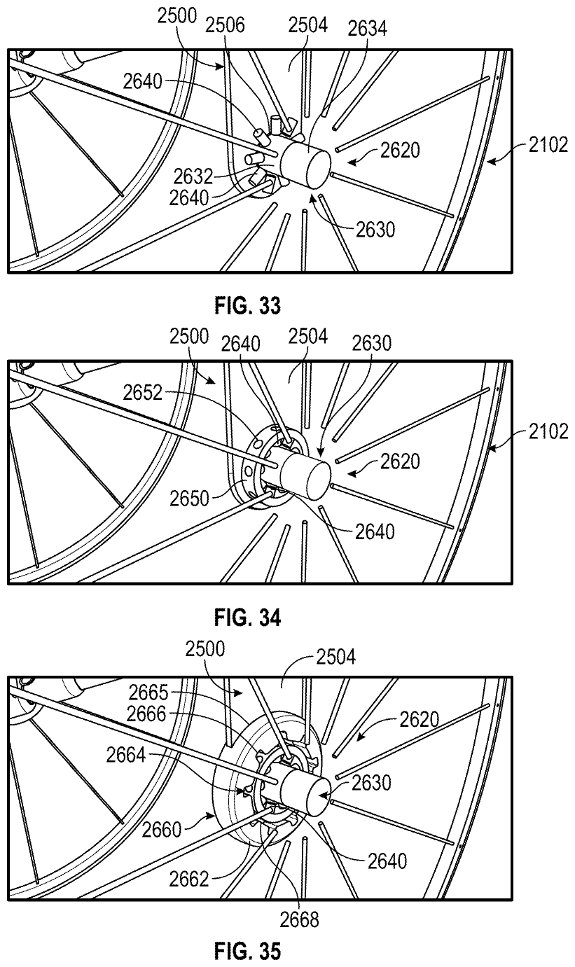

According to the exemplary embodiment shown in FIGS. 24-38, various components of the wheelchair 10 have been redesigned or reconfigured such that the wheelchair 10 has size adjustability to provide a size adjustable wheelchair, shown as adjustable wheelchair 2000. More specifically, the seat assembly 270 and various of the connectors 1000 have been reconfigured to facilitate adjusting the width, depth, and height of the user support assembly 100 to accommodate various sized occupants, as well as facilitate increasing the size of the adjustable wheelchair 2000 as a user ages and grows (e.g., from adolescence/childhood to adulthood) during ownership of the adjustable wheelchair 2000.

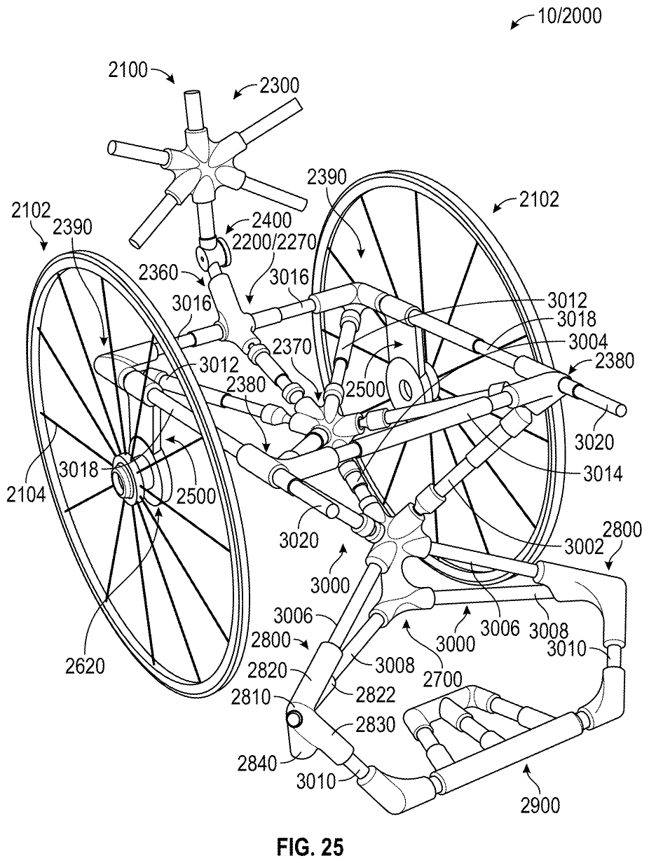

As shown in FIGS. 24 and 25, the adjustable wheelchair 2000 includes a chassis or chassis assembly, shown as adjustable user support assembly 2100, a first pair of rear wheels, shown as rear wheels 2102, and a pair of front wheels, shown as front caster wheels 2110. As shown in FIGS. 24-29, the adjustable user support assembly 2100 includes (a) a seat bottom, shown as seat 2200, (b) a seat back, shown as backrest 2300, (c) a connector or coupler, shown as backrest post 2400, coupling the backrest 2300 to the seat 2200, (d) axle supports, shown as axle supports 2500, coupled to the seat 2200, (e) an axle assembly, shown as rear axle assembly 2600, coupled to and supported by the axle supports 2500, (f) a central support, shown as central hub 2700, coupled to the seat 2200, (g) a pair of front wheel supports, shown as front caster supports 2800, coupled to the central hub 2700, and (h) a foot support, shown as footrest 2900, coupled to the front caster supports 2800. As shown in FIG. 24, the rear wheels 2102 are coupled to and supported by opposing ends of the rear axle assembly 2600, and the front caster wheels 2110 are coupled to the front caster supports 2800. As shown in FIGS. 24-29, the seat 2200, the central hub 2700, the front caster supports 2800, and the footrest 2900 are coupled together with a plurality of frame members (e.g., tubes, rods, pultruded carbon fiber tubes or rods, polymer tubes or rods, etc.), shown as connectors 3000, such that the seat 2200, the central hub 2700, the front caster supports 2800, the footrest 2900, and the connectors 3000 form a three-dimensional (“3D”) truss frame.

As shown in FIGS. 24-29, the seat 2200 of the adjustable user support assembly 2100 is configured as an assembly, shown as seat assembly 2270, including plurality of smaller, segmented components that are assembled, rather than having a monolithic or unitary seat pan structure (e.g., like in FIGS. 1-9). As shown in FIGS. 25-29, the seat assembly 2270 includes a first support, shown as rear hub 2360, a second support, shown as center seat hub 2370, a pair of third supports, shown as front seat supports 2380, and a pair of fourth seat supports, shown as rear seat supports 2390, and a plurality of the connectors 3000. According to an exemplary embodiment, the rear hub 2360, the center seat hub 2370, the front seat supports 2380, the rear seat supports 2390, and the connectors 3000 form a truss or space frame that supports a seat plate (e.g., similar to the seat plate 350).

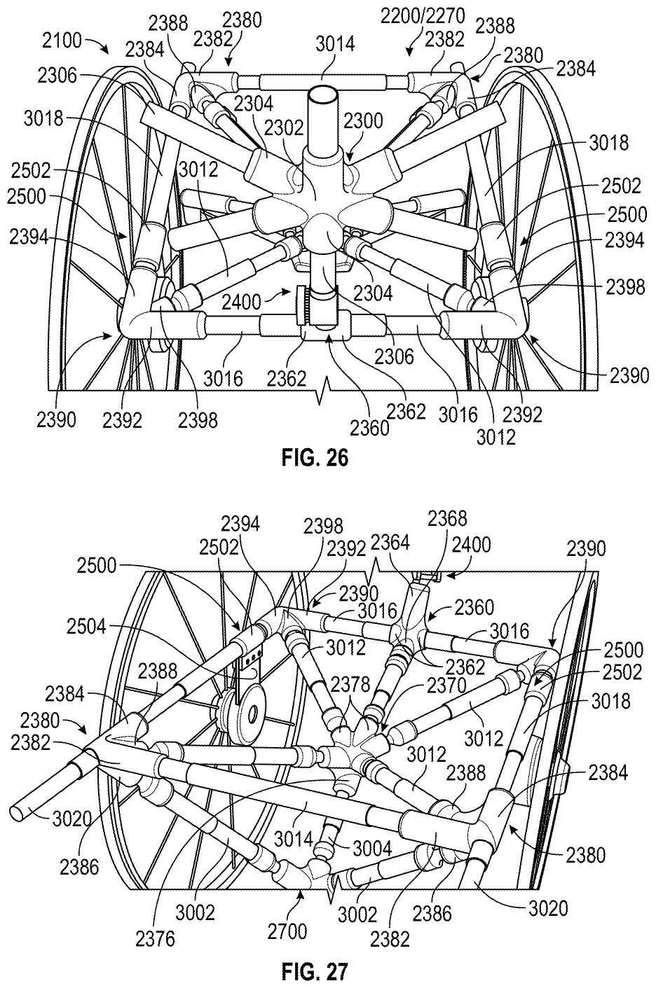

As shown in FIGS. 26 and 27, the rear hub 2360 includes a pair of first interfaces, shown as rear seat support protrusions 2362, extending laterally outward (e.g., left and right) towards the rear seat supports 2390; a second interface, shown as lower backrest post protrusion 2364, extending vertically upward; and a third interface, shown as center seat support protrusion 2368, extending longitudinally forward towards the center seat support 370. As shown in FIGS. 27-30, the center seat hub 2370 includes a first interface, shown as central hub protrusion 2376, extending downward at a forward angle towards the central hub 2700 and a second plurality of interfaces, shown as support protrusions 2378, extending horizontally outward at an upward angle towards the rear hub 360, the front seat supports 380 and the rear seat supports 390. In some embodiments, the center seat hub 2370 includes a seat pad (e.g., similar to the center seat plate pad 379). As shown in FIGS. 26-29, the front seat supports 2380 include first interfaces, shown as front seat support protrusions 2382, extending laterally inward towards each other; second interfaces, shown as rear seat support protrusions 2384, extending longitudinally rearward towards the rear seat supports 2390; third interfaces, shown as central hub protrusions 2386, extending downward at an inward and rearward angle towards the central hub 700; and fourth interfaces, shown as center seat hub protrusions 2388, extending horizontally/radially inward at a downward angle towards the center seat hub 2370. In some embodiments, the front seat supports 2380 include a seat pad (e.g., similar to the front seat plate pads 389). As shown in FIGS. 26 and 27, the rear seat supports 2390 include first interfaces, shown as rear hub protrusions 2392, extending laterally inward towards the rear hub 2360; second interfaces, shown as front seat support protrusions 2394, extending longitudinally forward towards the front seat supports 2380; and third interfaces, shown as center seat hub protrusions 2398, extending horizontally/radially inward at a downward angle towards the center seat hub 2370. In some embodiments, the rear seat supports 2390 include a seat pad (e.g., similar to the rear seat plate pads 399).

As shown in FIG. 26, the backrest 2300 includes a main body, shown as backrest hub 2302, and a plurality of frame members (e.g., tubes, rods, pultruded carbon fiber tubes or rods, polymer tubes or rods, etc.), shown as backrest extensions 2306. The backrest hub 2302 includes a plurality of interfaces, shown as backrest protrusions 2304. One of the backrest protrusions 2304 interfaces with and receives an upper end of the backrest post 2400, thereby coupling the backrest 2300 to the seat assembly 2270. The remaining backrest protrusions 2304 interface with and receive the backrest extensions 2306. The backrest extensions 2306 may be interchangeable with different sized extensions to facilitate adjusting the size of the backrest 2300 to accommodate different sized users.

In some embodiments, the backrest post 2400 is angle-adjustable and, thereby, facilitates user adjustment of an angle of the backrest 2300 relative to the seat 2200 (e.g., an incremental hinge with a push button to adjust the angle and fold the backrest 2300 flat, for user comfort, to fold the backrest 2300 for improved stowability and transportability, etc.). In some embodiments, the backrest post 2400 is additionally or alternatively height-adjustable and, thereby, facilitates user adjustment of a height of the backrest 2300 relative to the seat 2200.

As shown in FIGS. 28 and 29, the central hub 2700 has a first or upper support portion, shown as upper support 2710, a second or middle support portion, shown as center support 2720, and a third or lower support portion, shown as lower support 2730, with the center support 2720 connecting the upper support 2710 and the lower support 2730 together. The upper support 2710 includes (a) a pair of first upper interfaces, shown as front seat support protrusions 2712, that extend upward from the upper support 710 at an outward angle in a “Y-shape” towards the front seat supports 2380, (b) a second upper interface, shown as center seat hub protrusion 2714, extending upward from a rear side of the upper support 2710 at an outward angle toward the center seat hub 2370, and (C) a pair of third upper interfaces, shown as caster support protrusions 2716, extending outward from opposing sides of the upper support 2710 at a downward and forward angle toward the front caster supports 2800. The lower support 2730 includes a pair of lower interfaces, shown as caster support protrusions 2732, extending outward from opposing sides of the lower support 2730 at a forward angle toward the front caster supports 2800. In some embodiments, the upper support 2710 is a separate component from the lower support 2730 (e.g., the central hub 2700 does not include the center support 720). In such embodiments, the upper support 2710 and the lower support 2730 may be coupled using one of the connectors 3000.

As shown in FIG. 25, the front caster supports 2800 include a main body, shown as caster support hub 2810, having (a) a first interface, shown as upper central hub protrusion 2820, that extends inward from the caster support hub 2810 at an upward and rearward angle toward the central hub 2700, (b) a second interface, shown as lower central hub protrusion 2822, positioned beneath the upper central hub protrusion 2820 and that extends inward from the caster support hub 2810 at a rearward angle toward the central hub 2700, (c) a third interface, shown as footrest protrusion 2830, that extends inward from the caster support hub 810 at an downward and forward angle toward the footrest 2900, and (d) a fourth interface, shown as caster mount 840, that extends downward from the caster support hub 810. According to an exemplary embodiment, the caster mounts 840 are configured to treadably receive a threaded post of the front caster wheels 2110 to detachably couple the front caster wheels 2110 to the front caster supports 800.

As shown in FIGS. 24 and 25, the footrest 2900 is configured as an assembly including plurality of smaller, segmented components that are assembled, rather than having a monolithic or unitary footrest structure (e.g., like in FIGS. 1-23).

As shown in FIGS. 25-29, the seat assembly 2270 (e.g., the rear hub 2360, the center seat hub 2370, the front seat supports 2380, the rear seat supports 2390, various of the connectors 3000) is coupled to the central hub 700 using a subset of the connectors 3000. More specifically, the connectors 3000 include (a) first connectors, shown as front seat connectors 3002, that extend between and are received by the central hub protrusions 2386 of the front seat supports 2380 and the front seat support protrusions 2712 of the upper support 2710 of the central hub 2700 and (b) a second connector, shown a rear seat connector 3004, that extends between and is received by the central hub protrusion 2376 of the center seat hub 2370 and the center seat hub protrusion 2714 of the upper support 2710 of the central hub 2700. Accordingly, the front seat connectors 3002 and the rear seat connector 3004 couple the seat 2200 and the central hub 2700 together.

As shown in FIGS. 25 and 29, the connectors 3000 include (a) third connectors, shown as upper caster support connectors 3006, that extend between and are received by the caster support protrusions 2716 of the upper support 2710 of the central hub 2700 and the upper central hub protrusions 2820 of the front caster supports 800 and (b) fourth connectors, shown as lower caster support connectors 3008, that extend between and are received by the caster support protrusions 2732 of the lower support 2730 of the central hub 2700 and the lower central hub protrusions 2822 of the front caster supports 2800. Accordingly, the upper caster support connectors 3006 and the lower caster support connectors 3008 couple the central hub 2700 and the front caster supports 2800 together. As shown in FIG. 25, the connectors 3000 include fifth connectors, shown as footrest connectors 3010, that extend between and are received by the footrest protrusions 2830 of the front caster supports 2800 and caster protrusions (e.g., similar to the caster protrusions 920) of the footrest 2900. Accordingly, the footrest connectors 3010 couple the front caster supports 2800 and the footrest 2900 together.

As shown in FIGS. 25-30, the connectors 3000 include sixth connectors, shown as center seat hub connectors 3012, that extend between and are received by (a) the support protrusions 2378 of the center seat hub 2370 and (b) the center seat support protrusion 2368 of the rear hub 2360, the center seat hub protrusions 2388 of the front seat supports 2380, and the center seat hub protrusions 2398 of the rear seat supports 2390. Accordingly, the center seat hub connectors 3012 couple (a) the center seat hub 2370 with (b) the rear hub 2360, the front seat supports 2380, and the rear seat supports 2390.

As shown in FIGS. 25-27, the connectors 3000 include a seventh connector, shown as front seat support connector 3014, that extends between and are received by the front seat support protrusions 2382 of the front seat supports 2380. Accordingly, the front seat support connector 3014 couples the front seat supports 2380 together. As shown in FIGS. 25-27, the connectors 3000 include eighth connectors, shown as rear seat support connectors 3016, that extend between and are received by the rear seat support protrusions 2362 of the rear hub 2360 and the rear hub protrusions 2392 of the rear seat supports 2390. Accordingly, the rear seat support connectors 3016 couple the rear seat supports 2390 with the rear hub 2360. As shown in FIGS. 25-27, the connectors 3000 include ninth connectors, shown as side seat support connectors 3018, that extends between and are received by the rear seat support protrusions 2384 of the front seat supports 2380 and the front seat support protrusions 2394 of the rear seat supports 2390. Accordingly, the side seat support connectors 3018 couple the front seat supports 2380 and the rear seat supports 2390 together. As shown in FIGS. 25, 27, and 28, the connectors 3000 includes tenth connectors, shown as handles 3020, that interface with apertures in the front seat supports 2380 opposite the rear seat support protrusions 2384.

According to an exemplary embodiment, one or more of the connectors 3000 have an adjustable length to facilitate adjusting the width, depth, and/or height of the adjustable user support assembly 2100. In some embodiments, the one or more of the connectors 3000 have a telescoping configuration or structure (e.g., two or more tubes telescoped together) to facilitate expanding and retracting the length thereof with a locking component (e.g., a twist-lock mechanism, a clamp, etc.) to facilitate locking the connectors at a desired length. By way of example, the front seat connectors 3002 and the rear seat connector 3004 may have an adjustable length to selectively vary the distance between the seat assembly 2270 and the central hub 2700, and thereby vary the height of the adjustable user support assembly 2100. By way of another example, the center seat hub connectors 3012, the front seat support connector 3014, the rear seat support connectors 3016, and the side seat support connectors 3018 may have an adjustable length to selectively vary the width and/or depth of the seat assembly 2270.

In some embodiments, as shown in FIG. 31, the ends of the center seat hub connectors 3012, the rear seat connector 3004, and the front seat connectors 3002 include first connection interfaces, shown as magnetic connection interfaces 3330. In such embodiments, a ball bearing (e.g., a 400-series ferritic stainless steel ball bearing) may be disposed (e.g., bonded) within each of the central hub protrusion 2376 of the center seat hub 2370, the support protrusions 2378 of the center seat hub 2370, the central hub protrusions 2386 of the front seat supports 2380, the center seat hub protrusions 2388 of the front seat supports 2380, the center seat hub protrusions 2398 of the rear seat supports 2390, the center seat support protrusion 2368 of the rear hub 2360, the front seat support protrusions 2712 of the central hub 2700, and the center seat hub protrusion 2714 of the central hub 2700. In such embodiments, the magnetic connection interfaces 3330 are configured to engage with the ball bearings such that the angles of the various connectors can freely adjust to natural positions as the size of the adjustable user support assembly 2100 is increased or decreased.

In some embodiments, as shown in FIG. 32, the ends of the center seat hub connectors 3012, the rear seat connector 3004, and the front seat connectors 3002 include second connection interfaces, shown as ball joint interfaces 3340. In such embodiments, a receiving cup may be disposed (e.g., bonded) within each of the central hub protrusion 2376 of the center seat hub 2370, the support protrusions 2378 of the center seat hub 2370, the central hub protrusions 2386 of the front seat supports 2380, the center seat hub protrusions 2388 of the front seat supports 2380, the center seat hub protrusions 2398 of the rear seat supports 2390, the center seat support protrusion 2368 of the rear hub 2360, the front seat support protrusions 2712 of the central hub 2700, and the center seat hub protrusion 2714 of the central hub 2700. In such embodiments, the ball joint interfaces 3340 are configured to engage with the receiving cups such that the angles of the various connectors can freely adjust to natural positions as the size of the adjustable user support assembly 2100 is increased or decreased.

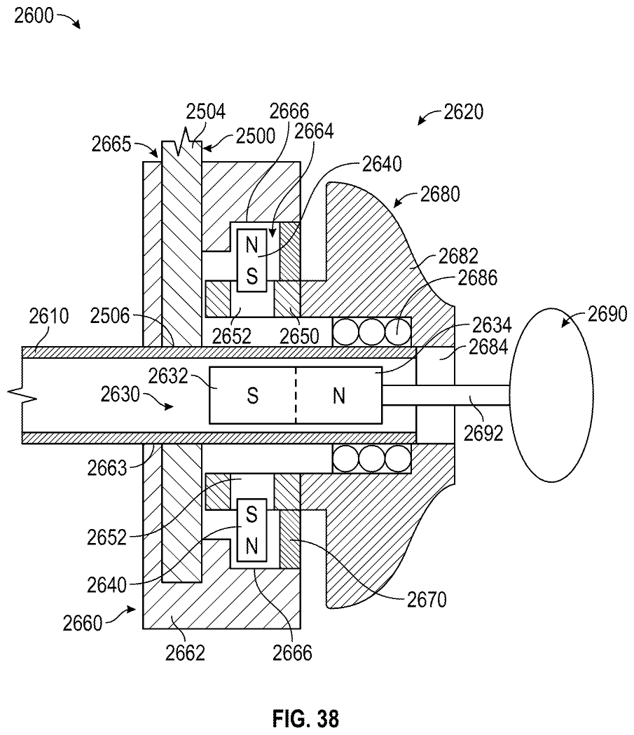

As shown in FIGS. 26, 27, and 33-38, each of the axle supports 2500 includes (a) a first component, shown as axle support clamp 2502, coupled to and positioned along a respective one of the side seat support connectors 3018 proximate the rear seat supports 2390 and (b) a second component, shown as axle support plate 2504, coupled to the axle support clamp 2502. The axle support clamp 2502 thereby couples the axle support plate 2504 to the seat assembly 2270. As shown in FIGS. 33 and 38, a lower portion of each of the axle support plates 2504 defines an axle aperture or interface, shown as axle bore 2506, configured to receive and support a portion of the rear axle assembly 2600, as described in more detail herein.

As shown in FIGS. 24 and 33-38, the rear axle assembly 2600 includes an elongated shaft, shown as axle shaft 2610, and a pair of wheel hub assemblies, show as wheel hub assemblies 2620, coupled to opposing ends of the axle shaft 2610 and the rear wheels 2102. As shown in FIGS. 33-38, each of the wheel hub assemblies 2620 includes (a) a magnetic insert, shown as radial magnet 2630, (b) a plurality of brake magnets, shown as brake magnets 2640, (c) a magnet guide or ring, shown as magnet collar 2650, (d) a main housing, shown as brake housing 2660, (e) a retainer, shown as retaining ring 2670, (f) a hub, shown as wheel hub 2680, and (g) an actuator, shown as brake knob 2690.

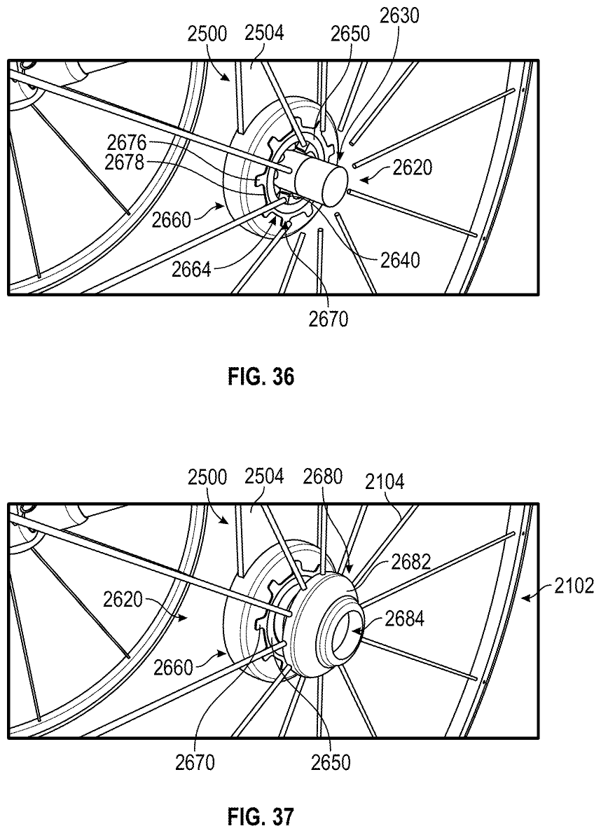

As shown in FIGS. 35 and 38, the brake housing 2660 includes a body, shown as brake body 2662, defining a first aperture, shown as axle bore 2663, a second aperture, shown as support plate slot 2665, and a radial channel, shown as brake channel 2664, recessed into an exterior face of the brake body 2662. The brake channel 2664 has a varying profile including first portions, shown as notched portions 2666, and second portions, shown as non-notched portions 2668, alternating along a periphery of the brake channel 2664.

As shown in FIGS. 35 and 38, the end of the axle support plate 2504 opposite the axle support clamp 2502 extends through the support plate slot 2665 of the brake housing 2660 such that the axle bore 2506 of the of the axle support plate 2504 and the axle bore 2663 of the brake housing 2660 align to receive an end of the axle shaft 2610. As shown in FIG. 38, the radial magnet 2630 is disposed within the axle shaft 2610 proximate the end thereof. As shown in FIGS. 33 and 38, the radial magnet 2630 includes a first portion, shown as first pole portion 2632, and a second portion, shown as second pole portion 2634, longitudinally stacked with the first pole portion 2632. According to an exemplary embodiment, the first pole portion 2632 and the second pole portion 2634 have opposing poles (e.g., south and north, north and south).

As shown in FIGS. 35 and 38, the magnet collar 2650 is disposed within the brake channel 2664 of the brake housing 2660, with the axle shaft 2610 extending through the magnet collar 2650. The magnet collar 2650 defines a plurality of apertures, shown as magnet apertures 2652, extending through a sidewall thereof and spaced along a periphery thereof. As shown in FIGS. 33-36 and 38, the brake magnets 2640 are radially spaced about the periphery of the radial magnet 2630 in alignment with the magnet apertures 2652 of the magnet collar 2650. As shown in FIGS. 36 and 38, the retaining ring 2670 has a profile with first portions, shown as low portions (e.g., teeth), shown as high portions 2676, and second portions, shown as low portions 2678, alternating along a periphery thereof such that the profile of the retaining ring 2670 matches the profile of the brake channel 2664 of the brake housing 2660 and can be inserted therein between the brake body 2662 and the magnet collar 2650.

As shown in FIGS. 37 and 38, the wheel hub 2880 has a body, shown as hub body 2682, that defines a passage, shown as hub passage 2684. As shown in FIG. 37, the hub body 2682 interfaces with a connecting structure, shown as spokes 2104, of the rear wheel 2102. As shown in FIG. 38, the hub body 2682 is coupled to the magnet collar 2650 and that the hub passage 2684 at least partially receives the end of the axle shaft 2684. In some embodiments, the wheel hub 2680 includes a bearing, shown as hub bearing 2686, disposed within the hub passage 2684 and positioned to interface with the end of the axle shaft 2610. Therefore, in such embodiments, the wheel hub 2680 and the magnet collar 2650 rotate relative to the axle shaft 2610.

As shown in FIG. 38, the brake knob 2690 is coupled to the radial magnet 2630 via a connector, shown as knob connector 2692. According to an exemplary embodiment, the brake knob 2690 can be pulled outward (e.g., as shown in FIG. 38) and pushed back in (as shown in FIG. 24) to reposition the radial magnet 2630 within the axle shaft 2610 to vary which of the first pole portion 2632 or the second pole portion 2634 of the radial magnet 2630 interacts with the brake magnets 2640. According to the exemplary embodiment shown as in FIG. 38, when the brake knob 2690 is pulled out, the first pole portion 2632 is positioned to interact with the brake magnets 2640 such that the radial magnet 2630 repels the brake magnets 2640, forcing the brake magnets 2640 to radially translate at least partially through the magnet apertures 2652 of the magnet collar 2650 and engage with the notched portions 2666 of the brake channel 2664 of the brake housing 2660 to rotationally lock the magnet collar 2650 and the wheel hub 2680 with the brake housing 2660 to prevent rotation of the rear wheel 2102. Then, by pushing the brake knob 2690 back in, the second pole portion 2634 is positioned to interact with the brake magnets 2640 such that the radial magnet 2630 attracts the brake magnets 2640 to retract back through the magnet apertures 2652 of the magnet collar 2650 and disengage from the notched portions 2666 of the brake channel 2664 to permit rotation of the rear wheel 2102. Accordingly, the wheel hub assemblies 2620 include magnetic locking brake or magnetically actuated braking assemblies.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

It is important to note that the construction and arrangement of the wheelchair 10, the adjustable wheelchair 2000, and the components thereof as shown in the various exemplary embodiments is illustrative only. Additionally, any element disclosed in one embodiment may be incorporated or utilized with any other embodiment disclosed herein.

1. A wheelchair comprising:
a seat;
a backrest configured to couple to the seat;
a pair of axle supports configured to couple to the seat, wherein the pair of axle supports is configured to support an axle and a pair of rear wheels;
a central hub configured to couple to the seat;
a pair of caster supports configured to couple to the central hub, wherein the pair of caster supports is configured to support a pair of front caster wheels; and
a footrest configured to couple to the pair of caster supports.

2. The wheelchair of claim 1, further comprising a plurality of connectors configured to extend between (a) the seat and the central hub, (b) the central hub and the pair of caster supports, and (c) the pair of caster supports and the footrest to couple the seat, the central hub, the pair of caster supports, and the footrest together to provide a three-dimensional truss frame.

3. The wheelchair of claim 2, wherein at least one of the plurality of connectors has an adjustable length.

4. The wheelchair of claim 3, wherein ends of the at least one of the plurality of connectors have magnetic connection interfaces.

5. The wheelchair of claim 3, wherein ends of the at least one of the plurality of connectors have ball joint interfaces.

6. The wheelchair of claim 2, wherein the plurality of connectors are tubular.

7. The wheelchair of claim 1, further comprising the pair of rear wheels and the pair of caster supports.

8. The wheelchair of claim 1, wherein the seat includes a plurality of seat components configured to be assembled together to provide the seat.

9. The wheelchair of claim 8, wherein the plurality of seat components includes:
a pair of rear seat supports;
a pair of front seat supports;
a rear seat hub configured to couple to the backrest;
a center seat hub; and
a plurality of seat connectors configured to couple the pair of rear seat supports, the pair of front seat supports, the rear seat hub, and the center seat hub together.

10. The wheelchair of claim 9, wherein at least one of the plurality of seat connectors has an adjustable length.

11. The wheelchair of claim 10, wherein all of the plurality of seat connectors have the adjustable length.

12. The wheelchair of claim 10, wherein ends of the at least one of the plurality of seat connectors have magnetic connection interfaces.

13. The wheelchair of claim 10, wherein ends of the at least one of the plurality of seat connectors have ball joint interfaces.

14. The wheelchair of claim 9, wherein the plurality of seat connectors are tubular.

15. The wheelchair of claim 9, wherein the plurality of seat components includes a plate supported by at least the pair of rear seat supports and the pair of front seat supports.

16. The wheelchair of claim 1, wherein at least a portion of at least one of the seat, the backrest, the pair of axle supports, the central hub, the pair of caster supports, or the footrest is additive-manufactured.

17. The wheelchair of claim 1, further comprising a pair of magnetic braking assemblies configured to brake the pair of rear wheels.

18. A wheelchair comprising:
a seat assembly including:
a pair of rear seat supports;
a pair of front seat supports;
a rear seat hub; and
a center seat hub;
a backrest configured to couple to seat assembly;
a pair of axle supports configured to couple to the seat assembly;
a central hub configured to couple to the seat assembly;
a pair of front wheel supports configured to couple to the central hub; and
a footrest configured to couple to the pair of front wheel supports.

19. The wheelchair of claim 18, further comprising a plurality of connectors configured to extend between (a) the central hub and the pair of front wheel supports, (b) the pair of front wheel supports and the footrest, (c) the central hub and the center seat hub, (d) the central hub and the pair of front seat supports, (d) the pair of front seat supports, (e) the pair of front seat supports and the pair of rear seat supports, (f) the pair of front seat supports and the center seat hub, (g) the pair of rear seat supports and the rear seat hub, (h) the pair of rear seat supports and the center seat hub, and (i) the rear seat hub and the center seat hub, wherein at least one of the plurality of connectors has an adjustable length.

20. A wheelchair comprising:
a seat assembly including:
a pair of rear seat supports;
a pair of front seat supports;
a rear seat hub;
a center seat hub; and
a first plurality of connectors configured to extend between the pair of rear seat supports, the pair of front seat supports, the rear seat hub, and the center seat hub;
a backrest;
a backrest post configured to extend between the rear seat hub and the backrest;
a pair of axle supports configured to couple to the seat assembly;
a central hub;
a pair of front wheel supports;
a footrest;
a second plurality of connectors configured to extend between the seat assembly, the central hub, the pair of front wheel supports, and the footrest; and
a pair of magnetic braking assemblies;
wherein at least one of:
at least one of the first plurality of connectors has an adjustable length; or
at least one of the second plurality of connectors has an adjustable length.
